(19) United States
(12) Patent Application Publication
(10) Pub. No.: US 2003/0179543 A1
(43) Pub. Date: Sep. 25, 2003

(54) Deformable shock absorbing mechanism for a computer apparatus or a precision apparatus

(75) Inventors: Sri M. Sri-Jayantha, Ossining, NY (US); Vijayeshwar D. Khanna, Millwood, NY (US); Fusanobu Nakamura, Yamato-shi (JP); Tetsuya Ohtani, Yokohama-shi (JP)

Correspondence Address: IBM CORPORATION, INTELLECTUAL PROPERTY LAW DEPT., P.O. BOX 218, YORKTOWN HEIGHTS, NY, 10598, US

(73) Assignee: International Business Machines Corporation, Armonk, NY

(21) Appl. No.: 10/106,145

(22) Filed: Mar. 25, 2002

(51) Int. Cl. G06F 1/16; A47B 95/00

(52) U.S. Cl. 361/683; 248/345.1; 312/223.2

(57) ABSTRACT

A deformable shock absorbing device for a computer apparatus or a precision apparatus is provided. An embodiment of the shock absorbing portion includes an outer disk, an inner substrate with a valve, and an elastic member therebetween, creating a cavity whose inflow or outflow is allowed by the valve. When the computer apparatus is moved away from a resting surface, the elastic membrane facilitates the inflation of the shock absorbing device with air or fluid and the device projects outwardly from the bottom surface of the computer. If the computer comes into sudden contact with the surface, the force of impact is absorbed by the shock absorbing device which deflates gradually. Thus, internal structures of the computer apparatus can be prevented from being damaged.

### FIELD OF THE INVENTION

The present invention relates to a deformable shock absorbing mechanism, more particularly, to a precision apparatus, such as a computer apparatus, provided with a structure for reducing a shock externally applied to the precision apparatus.

### BACKGROUND OF THE INVENTION

Notebook PCs (personal computers) and other small-sized and readily portable computer apparatus are widely used. To such computer apparatus, various kinds of vibrations or shocks may be applied. For example, it is known that a vibration is caused by the rotation of a CD-ROM or the like housed in a PC, which is referred to as a self-vibration. In addition, when a PC is used in a vehicle or the like, the PC may be subjected to vibrations caused by the motion of the vehicle.

A notebook PC is relatively lightweight and can be easily moved: for example, a user may draw the notebook PC that is in operation toward him or her to use it at a more convenient position. During this motion, a relatively large vibration is often applied to the notebook PC. Furthermore, a user may unintentionally apply a relatively large shock to a notebook PC. Typically a user tries to place a notebook PC by slipping his or her fingers from the edge of the computer and drops it on a desk. In such a case, a shock referred to as a z-shock is applied perpendicularly to a bottom surface of the notebook PC.

Such vibrations and shocks may result in damage to a particular precision apparatus housed within the computer apparatus. In particular, if the vibrations or shocks occur during reading from and writing to a HDD (hard disk drive) in the computer apparatus, the reading and writing of the HDD cannot be properly accomplished. According to an experiment conducted by the inventors, in the case where a user tried to place a notebook PC on a desk and the notebook PC was slipped from the fingers, when one edge thereof was on the desk and the other edge thereof is at a height of 75 mm above the desk (that is, the PC is tilted with respect to the desk), a shock amplitude of 600 g at 0.4 ms was recorded. However, a typical hard disk drive can tolerate a shock amplitude of 150 g at the most.

A shock absorbing pad having a relatively high rigidity is effective against the self-vibration described above. As for the computer apparatus such as the notebook PC, rubber pads having a relatively high rigidity have been provided as supports at four corners of the outer bottom surface thereof to reduce the self-vibration and also provide moderate shock protection.

However, such a pad cannot be expected to reduce a relatively large vibration or shock externally applied to the PC.

In order to reduce the z-shock, one might consider providing a highly shock absorbing rubber pad having a low rigidity on the bottom surface of the computer apparatus. However, rubber having a low rigidity, i.e. soft rubber, is less resistive to a shearing force, so that it may be damaged or stripped from the computer apparatus when the computer apparatus is dragged on the desk. In addition, such a soft rubber is inferior in its ability to absorb the self-vibration.

Another possibility is to provide a rubber pad having a high rigidity on the outer bottom surface of the computer apparatus and to provide a soft rubber within the computer apparatus for supporting a particular precision apparatus within the computer apparatus. However, if such rubber is housed in the computer apparatus, for example, provided under HDD, the computer apparatus becomes significantly more bulky. Therefore, this measure is not quite suitable for the computer apparatus that are required to be compact for portability, such as the notebook PC.

### SUMMARY OF THE INVENTION

The present invention provides a precision apparatus or a computer apparatus or the like that is itself provided with a cushion structure for absorbing a self-vibration as well as a relatively large vibration and shock. The cushion structure is preferably stain-free, lightweight, compact, and resistant to being stripped from the precision apparatus body. The precision apparatus or the like according to the present invention sufficiently supports the weight of hands of a user operating the apparatus as well as the weight of the apparatus itself and the key board strokes of the user while maintaining the above-described advantages.

The invention provides a shock absorbing device which differs from traditional dampers by allowing itself to reduce stiffness gradually (for example, after several seconds), after providing the timely shock absorption function during an unexpected impact event. The shock absorbing device of the present invention exhibits nonlinear stiffness characteristics to accommodate the forces applied to the precision apparatus resulting from the static and dynamic position thereof.

According to one aspect of the invention, a shock absorbing device for a precision apparatus is provided, comprising a chamber having at least one opening for mass flow.

According to another aspect of the invention, the shock absorbing device comprises a chamber wall which itself comprises an elastic member. The chamber wall further comprises an outer cap having a flat outer surface; and a substrate connected to an outer surface of the precision apparatus; and wherein said elastic member is between said outer cap and said substrate. The outer cap is preferably made of a metal or a metallic alloy.

According to another aspect of the invention, a precision apparatus for placing at a predetermined placement site is provided, which comprises a back surface that faces the placement site when the precision apparatus is placed; a viscoelastic member that contacts said back surface; and a holder; where said viscoelastic member is held between said holder and said precision apparatus.

According to a further aspect of the invention, a portable computer apparatus is provided, which apparatus comprises a shock absorbing means capable of being shrunk and having a restoring force; and support means for supporting said computer apparatus when the computer apparatus is placed, wherein said shock absorbing means projects outwardly further than said support means when the support means is not subjected to a self-weight of said computer apparatus.

According to another aspect of the invention, a shock absorbing body capable of being attached to a precision apparatus is provided, where the shock absorbing body comprises a containing section for containing a fluid for absorbing a shock; and an opening for introducing the fluid into said containing section and discharging the fluid from the containing section, wherein a discharge speed of the fluid discharged from said containing section is lower than an introduction speed of the fluid introduced into the containing section.

According to a further aspect of the invention, a shock absorbing body capable of being attached to a portable precision apparatus is provided, comprising a joint surface to be joined to said precision apparatus; an elastic member for reducing a shock; a holding member for holding said elastic member on said joint surface; and a support member capable of supporting said precision apparatus, that is made of a material harder than said elastic member, wherein when said shock absorbing body is in a free state, a first distance from said joint surface to an outermost portion of said holding member is larger than a second distance from the joint surface to an outermost portion of said supporting member.

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a perspective view of a computer apparatus.

FIG. 2 is a cross-sectional view of the computer apparatus shown in FIG. 1 taken along the line II-II.

FIG. 3 is a plan view of a bottom outside surface of the computer apparatus shown in FIG. 1.

FIG. 3A is a side view of a computer apparatus where the computer apparatus is tilted with respect to a surface.

FIG. 3B is a side view of the computer apparatus shown in FIG. 3A during impact with the surface shown in FIG. 3A.

FIG. 4A is a perspective view of a component of a shock absorbing portion, specifically, a projection formed on the inner surface of the bottom of the apparatus body.

FIG. 4B is a perspective view of a component of a shock absorbing portion, specifically, a shock absorbing member.

FIG. 4C is a perspective view of a component of a shock absorbing portion, specifically, a cap for keeping the shock absorbing member held in the projection formed on the apparatus body.

FIG. 5 is a cross-sectional view of the computer apparatus shown in FIG. 1 taken along the line II-II, illustrating a state where the computer apparatus is distant from a surface.

FIG. 5A is a plan view of a bottom outside surface of a computer apparatus having a shock absorbing portion.

FIG. 6 is a plan view of a bottom outside surface of a computer apparatus, having shock absorbing portions.

FIG. 7 is a partial cross-sectional view of a computer apparatus having a shock absorbing portion.

FIG. 8 is a perspective exploded view of the shock absorbing portion shown in FIG. 7.

FIG. 9A depicts the shock absorbing portion of FIGS. 7-8, when the computer apparatus is lifted from a surface.

FIG. 9B depicts the shock absorbing portion of FIG. 9A, when the computer apparatus comes into contact with the surface.

FIG. 10 is an exploded view illustrating a modification of a shock absorbing portion.

FIG. 10A presents experimental data of the shock amplitude as a function of the shock-pulse-duration for a notebook computer apparatus with and without the shock absorbing portion of FIG. 10 for various applied shocks.

FIG. 10B is a plan view of a bottom outside surface of a computer apparatus having the shock absorbing portion shown in FIG. 10.

FIG. 10C is a perspective view of a shock absorbing portion which is a modification of the shock absorbing portion shown in FIG. 10 showing placement on a notebook computer apparatus.

FIG. 11 is an exploded view illustrating a shock absorbing portion.

FIG. 12 is an exploded view illustrating a shock absorbing portion.

FIG. 13A is a perspective view illustrating a shock absorbing portion.

FIG. 13B is a cross-sectional view of the shock absorbing portion shown in FIG. 13A taken along the line b-b.

FIG. 14 is a partial side view of a computer apparatus provided with a shock absorbing portion with a support wall.

FIG. 15A is a diagram for illustrating the function of a shock absorbing portion with a support wall, showing a state where the computer apparatus is distant from a surface.

FIG. 15B is a diagram for illustrating the function of the shock absorbing portion with a support wall shown in FIG. 15A, showing a state where the computer apparatus comes into contact with the surface.

FIG. 16 is a cross-sectional view of a computer apparatus with a slim height shock absorbing portion which is distant from a surface.

FIG. 16A is a cross-sectional view of the computer apparatus shown in FIG. 16 resting on a surface.

FIG. 16B presents experimental data of the shock amplitude as a function of time following an impact for a notebook computer apparatus with and without the shock absorbing portions shown in FIGS. 16 and 16A which are placed as shown in inset FIG. 16C. The expected simulation value due to the effect of shock absorbing portion of FIGS. 16 and 16A on a notebook computer is also shown.

FIG. 16C is a plan view of a bottom outside surface of a computer apparatus using two of the shock absorbing portions as shown in FIGS. 16 and 16A.

FIG. 17 illustrates another exemplary structure of a shock absorbing portion and the function thereof.

### DETAILED DESCRIPTION OF PREFERRED EMBODIMENTS

The present invention will be described herein in the context of an illustrative precision apparatus, i.e. A notebook personal computer (PC). It should be appreciated, however, that the present invention is not limited to this or any particular precision apparatus. Rather, the invention is more generally applicable to any precision apparatus where it is desirable to provide shock protection, such as personal digital assistants, mobile phones, portable music players and cameras. Moreover, although implementations of the present invention are described herein with reference to the bottom surface of a precision apparatus, it should be appreciated that the invention is not limited to such a configuration, but may be used to protect a precision apparatus from shock on any surface where such shock protection is desired.

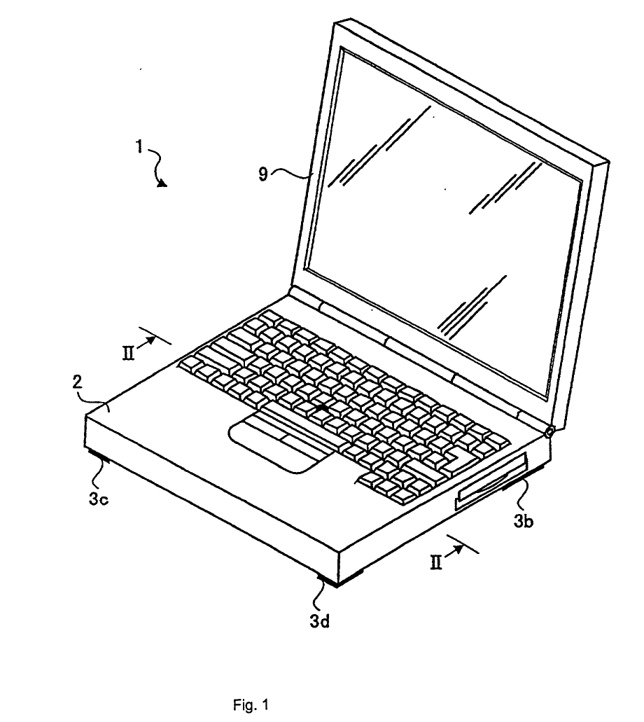

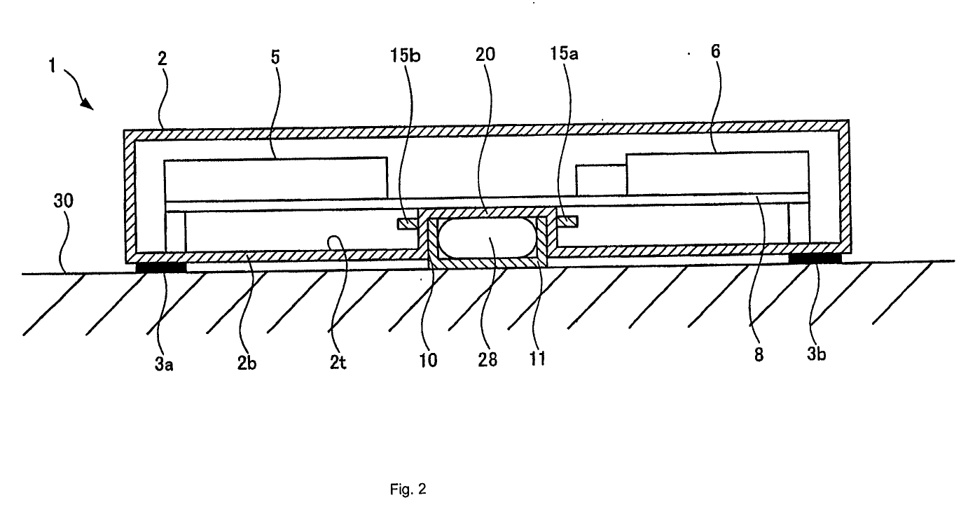

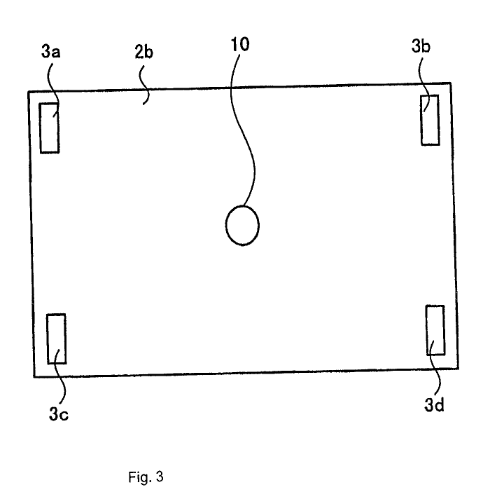

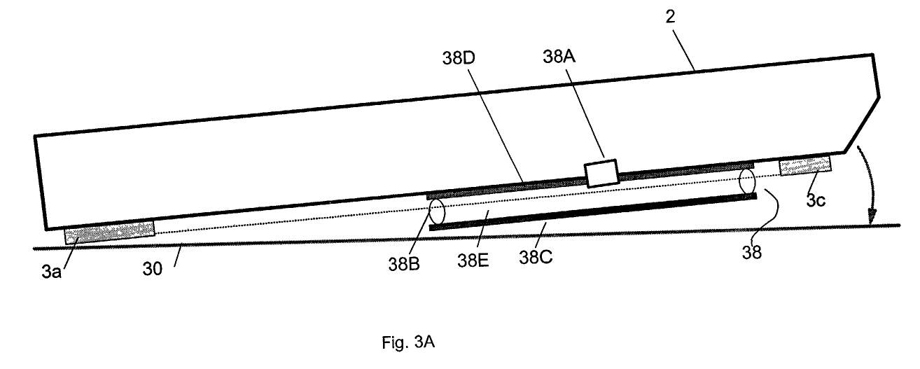

FIG. 1 is a perspective view of a computer apparatus according to a first embodiment of the present invention. FIG. 2 is a cross-sectional view of the computer apparatus shown in FIG. 1 taken along the line II-II. FIG. 3 is a plan view of a bottom surface of the computer apparatus shown in FIG. 1 viewed from outside.

The computer apparatus (precision apparatus) shown in FIG. 1 is a notebook computer including a housing body 2 for holding a particular precision apparatus therein that is provided with a keyboard as data input means, and a liquid crystal display 9 provided with a display screen for displaying an image, that is connected to the body 2. As shown in FIG. 2, an HDD (hard disk) 5 and CD-ROM device 6 are provided on a support substrate 8 in the body 2. In addition, although not shown, the computer apparatus 1 may include a component that would be provided in a typical computer apparatus, such as a CPU, memory, or PCI bus.

As shown in FIGS. 2 and 3, rubber pads (rubber supports) 3a, 3b, 3c, and 3d are provided near four corners of a back plate 2b of the bottom of the body 2. The rubber pads 3a, 3b, 3c, and 3d may be made of a material having a relatively high rigidity, and for example, the same material as that of a rubber leg provided on a conventional notebook PC for absorbing vibrations may be used. In addition, a shock absorbing portion 10 is provided, for example, near the center of the back plate 2b of the computer apparatus 1. The shock absorbing portion 10 is intended to absorb a shock applied to the computer apparatus 1 to prevent the housing and internal apparatus of the computer apparatus 1 from being damaged. The shock absorbing portion 10 will be described below.

FIGS. 3A and 3B illustrate another embodiment of the present invention, showing the principle of operation of a deformable shock absorbing portion 38. In FIG. 3A the portion 38 gradually self inflates through an orifice 38A due to weak restoring forces provided by a deformable elastic member 38B when the computer apparatus 2 is lifted away from a resting surface 30. Orifice 38A provides for gradual air flow both into and out of chamber 38E. Design parameters such as the orifice size and effective spring constant, or effective stiffness of the elastic member 38B, are chosen so that the self inflation takes place within about 5 seconds after lifting of the computer apparatus 2. FIG. 3B shows the effect of impact due to tilt drop. The moveable member 38C moves towards the stationary member 38D rapidly and the pressure of the air trapped in the chamber 38E rises according to the thermodynamic laws of adiabatic compression since the event of compression occurs preferably within about 2-3 ms. A negligible amount of trapped air can escape through the orifice 38A during the adiabatic compression process. The rise in air pressure, which is distributed throughout the chamber 38E, decelerates the moving computer apparatus gradually (preferably in about 2-3 ms) to rest. The high pressure air trapped in the chamber 38E leaks through the orifice following a shock event (post shock) and collapses preferably in less than about 5 seconds, but preferably longer than about 0.5 seconds driven by the weight of the computer apparatus 2. Once collapsed, the shock absorbing member preferably does not significantly support the weight of the computer apparatus 2 and preferably provides negligible stiffness (as a result of weak stiffness needed for self inflation) to the computer apparatus 2.

The shock absorbing portion thereby provides the shock absorbing function during an unexpected impact event through it's nonlinear stiffness characteristics and collapses slowly to accommodate the resting state of the computer apparatus. Note in this regard that although the shock absorbing member of the present invention is deformable, it preferably is capable of repeated use, so it does not permanently deform.

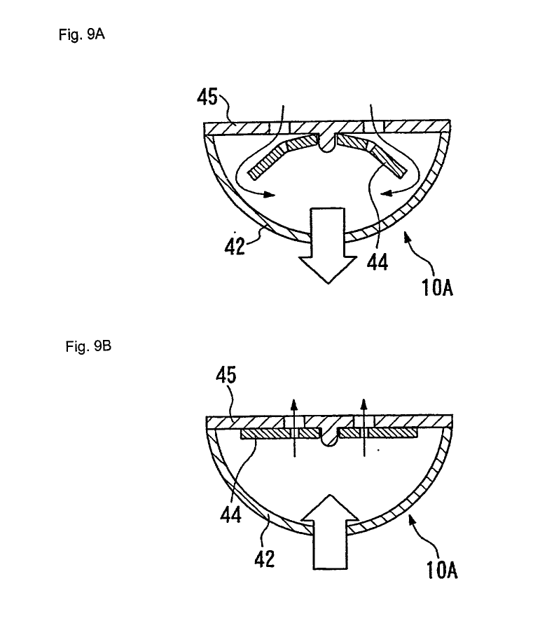

If desirable, the rate of self-inflation and post-shock-deflation of the shock absorbing portion can be independently controlled by means of a valve which renders the effective orifice size larger during self-inflation. In a preferred embodiment of the present invention, shown for example in FIGS. 9A and 9B, when the shock absorbing portion comes into contact with a surface after being lifted, the pressure inside the shock absorbing portion increases substantially adiabatically as a result of the gradual outflow of air through the valve 44. If such a valve is used with the embodiment of FIGS. 3A and 3B, the force acting against the impact motion as a result of the pressure increase within the chamber 38 can be described as follows:

F(t)=A*p₀*{y₀/[y₀−x(t)]}^{q} Eq. (1)

Where:

A=the cross-sectional area of stationary member 38D;

P₀=atmospheric pressure;

y₀=initial separation between stationary member 38D and movable member 38C when the computer apparatus is as shown in FIG. 3A;

x(t)=the difference between y₀ and the separation between stationary member 38D and movable member 38C when the computer apparatus is as shown in FIG. 3B;

q=exponent associated with adiabatic compression process (=1.4 for air);

t=time elapsed between the state shown in FIG. 3A and the state shown in FIG. 3B.

Those of skill in the art will appreciate that this force can be described more generally by a change in the volume of a chamber of a shock absorbing portion according to the present invention, (for example for the device of FIGS. 9A and 9B) as follows:

F(t)=A*p₀*{V₀/V(t)}^{q} Eq. (2)

Where:

A=the contact area of the shock absorbing portion with the precision apparatus;

P₀=atmospheric pressure;

V₀=the volume within the chamber when a precision apparatus is not in contact with a surface, i.e. in a free state;

V(t)=the volume within the chamber in the impact state;

q=adiabatic compression exponent;

t=time elapsed between the free state and the impact state.

It will also be appreciated by those of ordinary skill in the art that shock absorbing portion 38 has a changing control volume (CV). The control volume is the volume defined by an enclosed surface through which matter (gas, liquid or solid particles) with mass can flow. One aspect of the present invention, exhibited for example in the embodiments of FIGS. 3A and 3B, and FIGS. 7-17, is that the shock absorbing portion may include a chamber having a control volume which is subject to changing mass due to fluid flow. This is in contrast, for example, to the rubber pads 3a, 3b, 3c, and 3d and to the first embodiment.

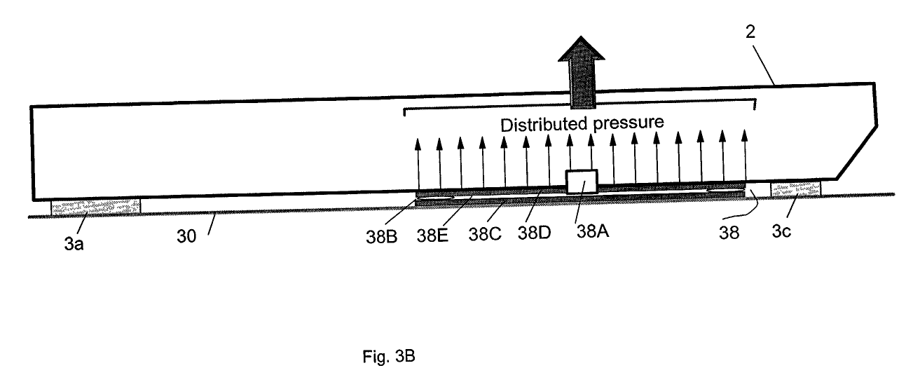

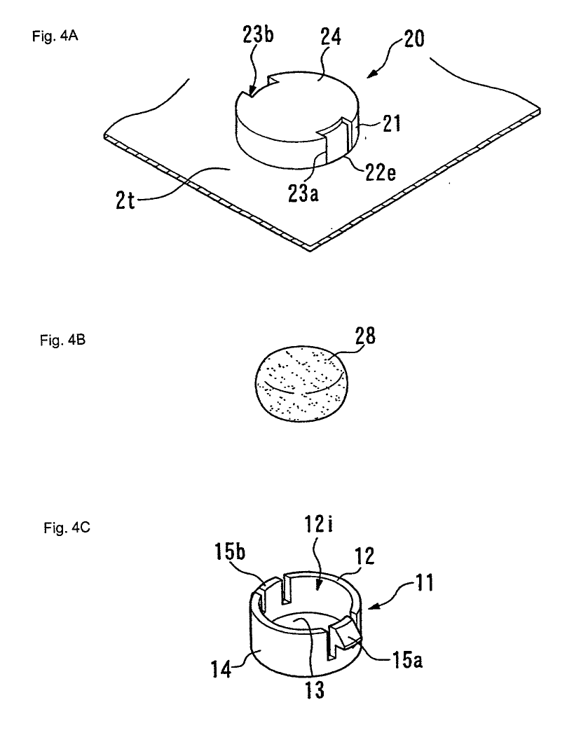

FIGS. 4A-4C are perspective views each showing a component of the shock absorbing portion 10 shown in FIGS. 2 & 3. FIG. 4A is a partial perspective view showing a projection formed on an inner surface 2t of the back plate 2b of the body 2, FIG. 4B is a perspective view of a shock absorbing member, and FIG. 4C is a perspective view of a cap for keeping the shock absorbing member held in the projection formed on the body 2.

As shown in FIGS. 2, 3 and 4A, the inner surface 2t of the back plate 2b has a recess 20 formed in such a manner that the material constituting the back plate 2b projects inwardly in the body 2, that is, upwardly in a direction vertical to the computer apparatus 1. The recess 20 is constituted by a side face 21 projecting inwardly from the inner surface 2t and a top surface 24 connected to the side face 21. In addition, the recess 20 has notches 23a and 23b extending from the top surface 24 to the inner surface 2t through the side face 21. The notches 23a and 23b are formed at positions diametrically opposed to each other. Furthermore, there is a cavity (space) in the recess 20 as shown in FIG. 2, and the notches 23a and 23b are formed so as to cut through the side face to the space.

In the space in the recess 20, a deformable shock absorbing member (having time dependent elastic characteristics) 28 is held by a cap (holder) 11 shown in FIG. 4C. The cap 11 has such a size and shape that it can hold the shock absorbing member 28 in its interior space 12i and be inserted into the space of the recess 20. Specifically, the cap 11 includes a side face 14 rising from a bottom surface 13 and latches 15a and 15b projecting laterally from a top edge 12 of the side face 14.

When the shock absorbing portion 10 shown in FIG. 2 is to be formed by combining the recess 20, shock absorbing member 28, and cap 11, the shock absorbing member 28 is first placed in the interior space 12i of the cap 11. Then, the cap 11 containing the shock absorbing member 28 is fitted into the recess 20 with the shock absorbing member 28 being interposed therebetween. In this fitting, the latches 15a and 15b of the cap 11 are inserted into the notches 23a and 23b of the recess 20, respectively, thereby introducing the cap 11 into the space in the recess 20.

In this regard, the shock absorbing member 28 may be made of a material, such as a spring, coil spring, rubber, resin, or fiber. Preferably, the material restores back to its original shape even if it has been collapsed for a long period. The material may preferably restore back to its original shape through an elastic restoring force.

Now, the function of the shock absorbing portion 10 constructed as described above will be described in detail below.

In a normal state where the computer apparatus 1 is placed on a flat surface, such as a desk surface (also referred to as a static rest condition), the shock absorbing member 28 is sandwiched between the bottom surface 13 of the cap 11 and the top surface 24 of the recess 20, and is vertically collapsed by the self-weight of the body 2 as shown in FIG. 2. Consequently, the top edge 12 of the cap 11 faces the top surface 24 of the recess 20, and the computer apparatus 1 is supported by the side face 14 and bottom surface 13 of the cap 11 via the top surface 24 of the recess 20 and by the rubber pads 3a, 3b, 3c, and 3d provided on the back plate 2b. In this state, the shock absorbing member 28 does not dominantly support the weight of the computer apparatus 1.

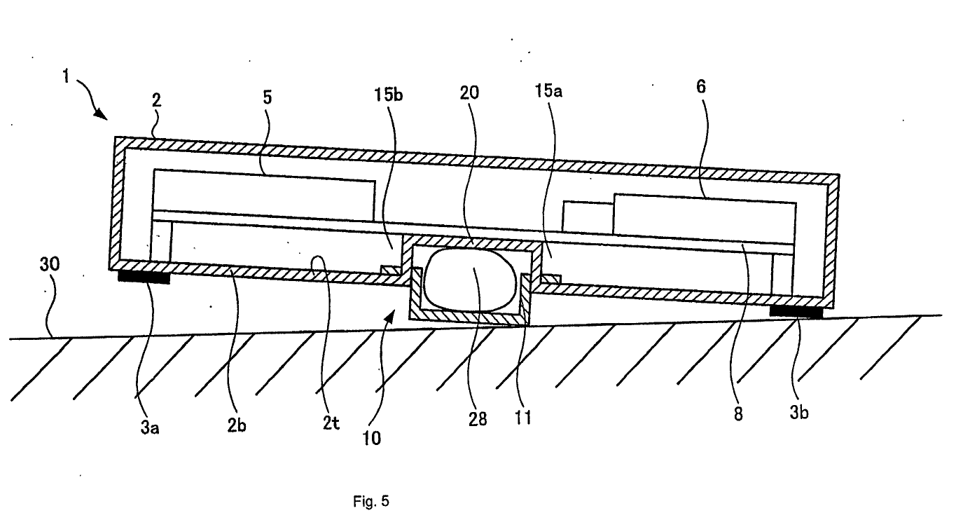

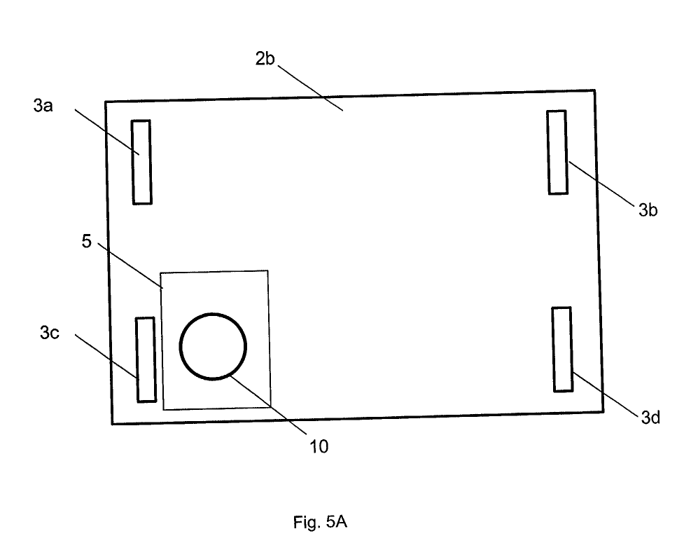

When the computer apparatus 1 is lifted and at least one of the rubber pads is gradually moved away from the resting surface 30, the shock absorbing member 28 is gradually released from the weight of the computer apparatus 1, so that the shock absorbing member 28, which has been collapsed between the bottom surface 13 and top surface 24, is restored to its original shape by, for example, the elastic restoring force. As a result, the cap 11 is moved outwardly from the recess 20 as shown in FIG. 5, and then the latches 15a and 15b are engaged with the lowermost parts 22e of the notches 23a and 23b of the recess 20. In this process, if a material having a large elastic restoring force, such as Sorbothane®, is used as the shock absorbing member 28, the collapsed member can be restored to its original shape quickly, for example, within 1 to 5 seconds.

In this way, when the pad 3a is distant from the floor surface 30 as shown in FIG. 5, the shock absorbing portion 10 projects outwardly further than the rubber pads 3a, 3b, 3c, and 3d. That is, the shock absorbing portion 10 may project by about 3 to 5 mm outside the conventional form factor envelope of the computer apparatus 1.

If the computer apparatus 1 is slipped from the user's fingers in this state, the shock absorbing portion 10 first comes into contact with the floor surface 30. Then, the shock absorbing member 28 contained in the shock absorbing portion 10 is collapsed by the self-weight of the computer apparatus 1 and thereby absorbs the shock generated. Thus, the computer apparatus 1 and the HDD 5 and the like provided in the body 2 thereof have a reduced shock applied thereto.

In the state where the computer apparatus 1 is placed on the desk surface 30 as described above, if the top surface 24 of the recess 20 and the top edge 12 of the cap 11 are moved away from each other and the computer apparatus 1 becomes supported by the shock absorbing member 28 contained in the cap 11, the computer apparatus 1 is unstable. Therefore, it is preferred that the shape, size, and elastic properties of the shock absorbing member 28 are suitably adjusted so that it is accommodated between the top surface 24 of the recess 20 and the bottom surface 13 of the cap 11 in the state shown in FIG. 2, and it projects outwardly further than the rubber pads 3a, 3b, 3c, and 3d provided on the computer apparatus 1 in the state shown in FIG. 5. Besides the adjustment of the shock absorbing member 28, the projection height of the recess 20 or the depth of the cap 11 may be adjusted, for example. Furthermore, while the shock absorbing member 28 shown in FIG. 4B has a spherical shape, it is not limited thereto in this embodiment, and for example, may have a cylindrical or rectangular parallelepiped shape.

As described above, in the computer apparatus 1 of the first embodiment, the shock absorbing portion 10 absorbs the shock generated when it comes into contact with the resting surface 30 or the like. Particularly, even if the computer apparatus 1 accidentally falls from a certain height onto the resting surface 30, the shock applied to the computer apparatus 1, for example, the vertical shock (z-shock) can be reduced.

In addition, in the computer apparatus 1, the engagement of the latches 15a, 15b of the cap 11 with the notches 23a, 23b of the recess 20 prevents the shock absorbing portion 10 from dropping off the computer apparatus 1. Therefore, differing from the case where a shock absorbing material is simply applied to the outside of the computer apparatus 1, even if the shock absorbing portion 10 is dragged on the floor surface or rubbed, it is not separated from nor does it drop off the computer apparatus 1, and therefore, the shock absorption effect can be provided for a long period.

In addition to the shock absorbing portion 10, the computer apparatus 1 is provided with the rubber pads 3a, 3b, 3c, and 3d so that the vibration caused by operation of, for example, a CD-ROM device 6 can be further reduced. The shock absorbing member 28 can also prevent the computer apparatus 1 from sliding on the resting surface 30.

The position where the shock absorbing portion is provided is not limited the center of the back plate 2b of the computer apparatus 1. For example, instead of the rubber pads 3a, 3b, 3c, and 3d, a plurality of shock absorbing portions 10 may be provided at the four corners of the back plate 2b of the computer apparatus 1. In addition, as shown in FIG. 5A, the shock absorbing portion 10 may be placed asymmetrically away from the center of the computer apparatus. Rubber pads 3a, 3b, 3c and 3d provide the traditional function of at least partly supporting the weight of the computer apparatus along with moderate shock protection. This configuration can lower cost by requiring only one shock absorbing portion while maintaining or improving the protection of, for example, an HDD 5 by placing the shock absorbing portion proximal to the HDD 5.

FIG. 6 is a plan view of a bottom surface of a computer apparatus according to another embodiment of the present invention, viewed from outside.

The computer apparatus 1A shown in FIG. 6 has a structure differing from that of the computer apparatus 1 according to the first embodiment in that shock absorbing portions 10A are provided at the four corners of the back plate 2b, rather than the shock absorbing portion 10 and rubber pads 3a, 3b, 3c, and 3d provided on the computer apparatus 1 shown in FIGS. 1 to 3 according to the first embodiment. In the computer apparatus 1A, a component similar to that of the computer apparatus 1 of the first embodiment is assigned with the same reference numeral and description thereof is omitted. The shock absorbing portion 10A will be described in detail below. Note that the shock absorbing portion 10A need not be provided in the configuration shown in FIG. 6, but may be utilized, for example, in the configuration shown in FIG. 5A or 3.

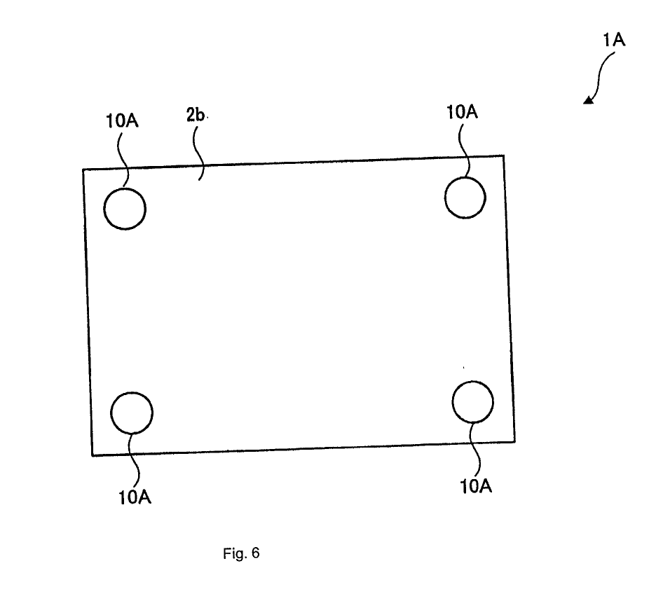

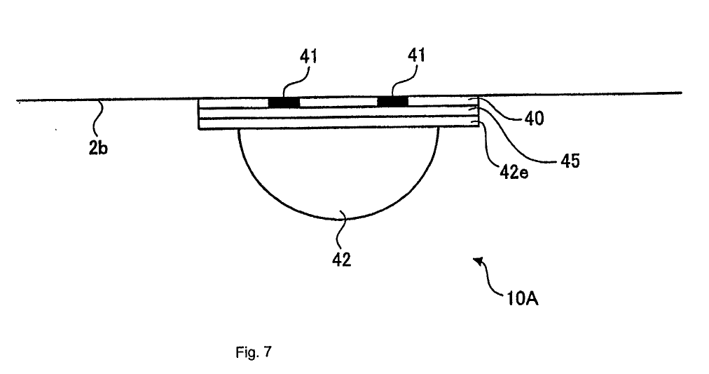

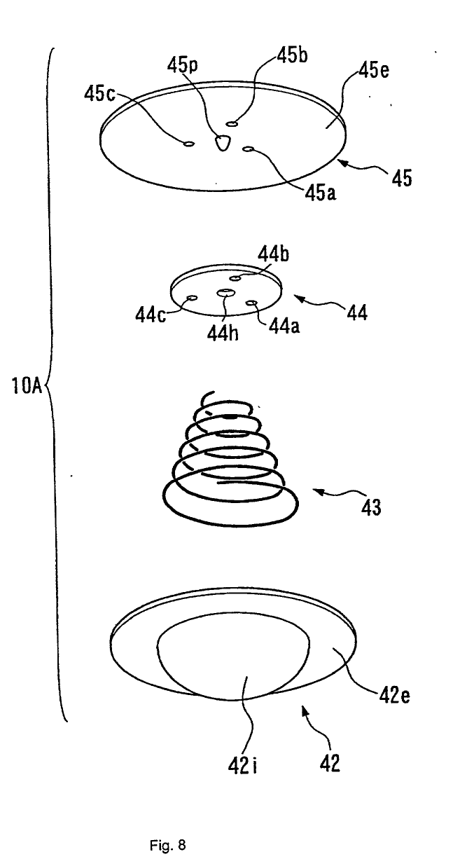

FIG. 7 is a partial cross-sectional view of the computer apparatus 1A having the shock absorbing portion 10A. FIG. 8 is a perspective exploded view of the shock absorbing portion 10A.

As shown in FIG. 7, on the back plate 2b of the computer apparatus 1A, the shock absorbing portion (shock absorbing body) 10A is provided via an air ventilation substrate 40 having an air vent 41 for allowing air (fluid) ventilation. As shown in FIG. 8, the shock absorbing portion 10A is constituted by a rubber cap (holding member) 42, an expansive spring (elastic member) 43 having a stiffness, a rubber valve 44 for controlling inflow and outflow of air, and a substrate 45 facing the joint surface of the air ventilation substrate 40 for adjusting a flow rate of air. The cap 42 and valve 44 may be made of any material so far as it has a plasticity and restorability, and for example, may be made of a resin. In addition, while the spring 43 is made of metal, it is not limited thereto and may be made of any material so far as it has stiffness and is expansive. For example, it may be made of a rubber, foamed resin, or the like.

In construction of the shock absorbing portion 10A, the spring 43 is housed in the interior (fluid containing region) of the body 42i of the cap 42. The spring 43 is compressed and the valve 44 and substrate 45 are laid over the spring, and then a peripheral portion 45e of the substrate 45 and the peripheral portion 42e of the cap 42 are joined to each other. Here, the valve 44 and substrate 45 are stacked so that the openings 44a, 44b, and 44c of the valve 44 are aligned with the openings 45a, 45b, and 45c of the substrate 45, respectively. In addition, a projection 45p in the substrate 45 is inserted into the center of the coil of the spring 43 through the opening 44h in the valve 44. The shock absorbing portion 10A thus constructed is joined to the air ventilation substrate 40. The air ventilation substrate 40 has a plurality of air vents 41, and air ventilation through the openings 45a, 45b, and 45c of the substrate 45 is accomplished via the air vents 41.

FIG. 9 is a diagram for illustrating the function of the shock absorbing portion 10A. FIG. 9A is a diagram for illustrating a state where the computer apparatus 1A is distant from the resting surface 30, and FIG. 9B is a diagram for illustrating a state where the computer apparatus 1A comes into contact with the resting surface 30. In FIGS. 9A and 9B, the spring 43 is omitted.

When the computer apparatus 1A is placed on the resting surface 30 as shown in FIG. 2 for example, the shock absorbing portion 10A is subjected to the self-weight of the computer apparatus 1A so that the spring 43 is shrunk or compressed and the cap 42 is collapsed. Then, if the computer apparatus 1A is moved away from the floor surface 30 as shown in FIG. 5 for example, the cap 42 of the shock absorbing portion 10A is restored to its original hemispherical shape by the elastic force of the spring 43. At this time, as shown in FIG. 9A, the valve 44 is moved away from the substrate 45 so that the substrate 45 is exposed, and air flows from outside into the cap 42 through the relatively large openings 45a, 45b, and 45c formed in the substrate 45 as indicated by arrows. Here, a large volume of air flows into the cap 42 in a short time. In this way, the cap 42 is restored to its original shape smoothly.

Now will be described the operation of the shock absorbing portion 10A when the computer apparatus 1A has been in the state shown in FIG. 5, i.e. not in complete contact with the resting surface 30, and then comes into contact with the resting surface 30, and the shock absorbing portion 10A becomes subjected to the self-weight of the computer apparatus 1A. First, the cap 42 of the shock absorbing portion 10A is collapsed and air in the body 42i of the shock absorbing portion 10A flows out of the cap. As shown in FIG. 9B, the valve 44 is attached to the substrate 45 so that the air flows out of the cap through the small openings 44a, 44b, and 44c formed in the valve 44. Therefore, in contrast to when air is flowing into the cap, the air in the body 42i of the cap 42 flows out gradually, taking a relatively long time. Thus, the shock generated when the shock absorbing portion 10A comes into contact with the floor surface 30 is absorbed by the spring 43 and the pressurized air, which is discharged gradually from the interior of the body 42i.

In this way, for this embodiment as shown in FIGS. 6-9, the shock absorbing portion 10A is provided with air vents of different sizes to adjust the rates of inflow and outflow of air. Therefore, if the computer apparatus 1A is moved away from the floor surface 30 the spring expands due to its elastic restoring force and air flows into the shock absorbing portion 10A to restore the shock absorbing portion 10A to its original shape. On the other hand, if a force is applied to the shock absorbing portion 10A, since air slowly flows out of the shock absorbing portion 10A, the shock absorbing portion 10A reduces the shock applied to the computer apparatus 1A.

The shock absorbing portion 10A may be further modified, for example the mechanism for outflow of air may be varied as described below. For the following embodiment, it will be understood that the spring 43 and the like housed in the shock absorbing portion 10A may be used as required. That is, the shock absorbing portion 10A may exhibit a self-inflation function, and the spring may be used in an auxiliary manner to allow the shock absorbing portion 10A to inflate at a required rate. Furthermore, it will be apparent to those skilled in the art that the coil spring is intended only for illustration, and may be substituted with a deformable hollow tube or the like. In addition, as described below, the cap 42 itself may exhibit the restoring or self-inflation function.

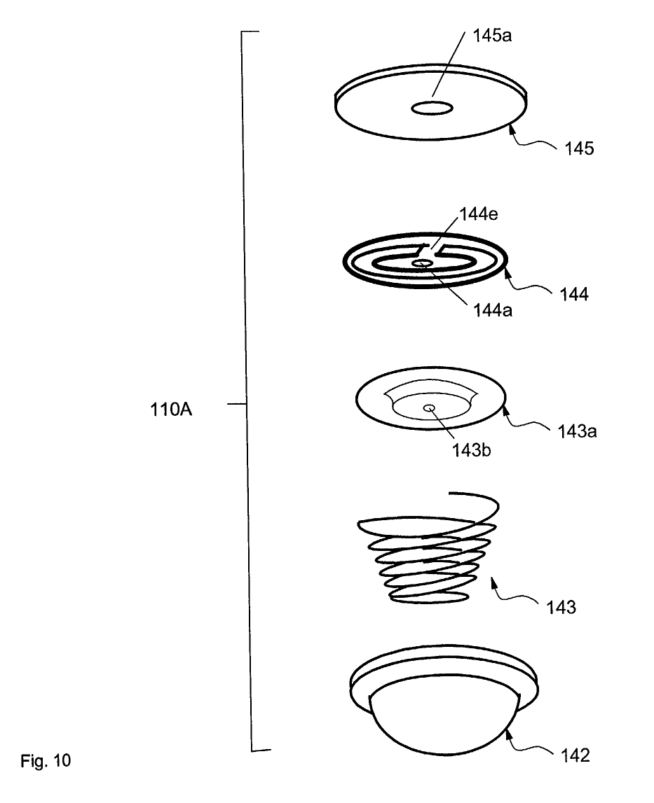

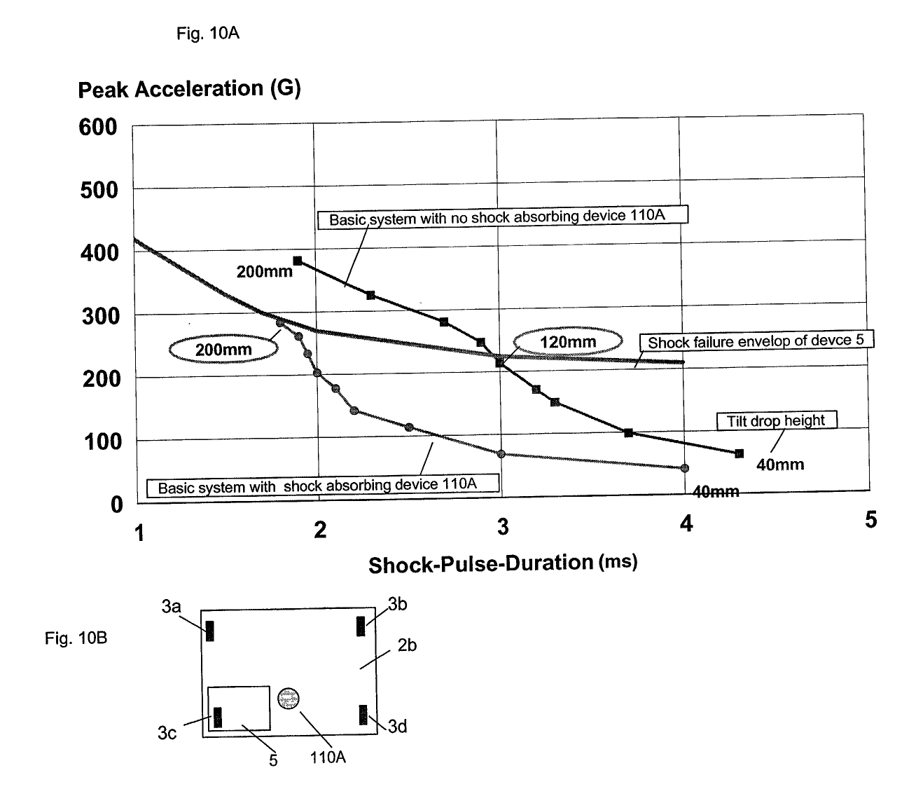

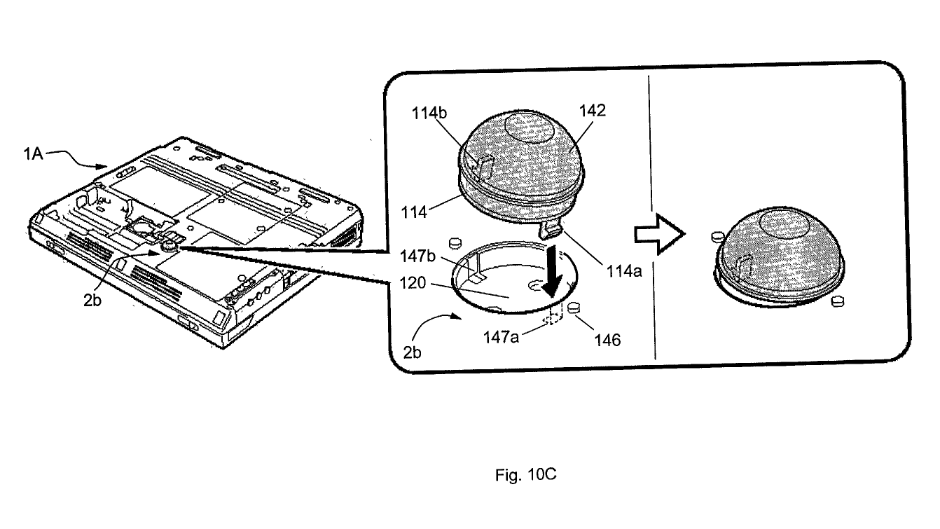

FIGS. 10, 11, and 12 are exploded views each illustrating a modification of the shock absorbing portion.

A shock absorbing portion 110A shown in FIG. 10 includes a substrate 145 having an opening 145a for air ventilation at the center thereof, a valve 144 having an opening 144a for air ventilation at the center thereof, a protective cap 143a with an opening 143b for air ventilation, a spring 143, and a cap 142. In the shock absorbing portion 110A, an end of the spring 143 is positioned at a spring holding recess 144e formed in the valve 144 to fix the end of the spring. When the shock absorbing portion 110A comes into contact with the floor surface 30 or the like and absorbs the shock by collapsing the shape thereof, or when it is restored to its original shape in a free state, it can operate the same as the shock absorbing portion 10A described above. That is, the shock absorbing portion 110A is constructed so that the speed of collapse of the shape is higher than that of restoration thereof.

Although not shown in FIG. 10, shock absorbing portion 110A may additionally include modifications such as an air seal between protector cap 143a and valve 144, as well as an air seal between valve 144 and substrate 145. Substrate 145 may be attached to computer apparatus 1A with adhesive tape.

FIG. 10A shows a family of experimentally generated plots showing improved shock protection when the shock absorbing portion 110A (including the air seals and tape described above) is used. Plotted is the peak force G as a function of the shock-pulse-duration in milliseconds-(ms). The shock failure envelope of device 5, a typical HDD is shown as the solid line. The top curve presents data for a basic notebook PC computer system with rubber pads 3a, 3b, 3c and 3d when dropped from various heights as indicated in the figure. The bottom curve shows corresponding data for the notebook PC device using the shock absorbing member 110A as shown in FIG. 10B. As can be seen from the data, an impact generated by dropping the PC from a height of 120 mm is sufficient to damage the HDD 5 for the conventional notebook PC, whereas when the shock absorbing member 110A is used, a drop from up to 200 mm can be tolerated before damage to the HDD 5 is predicted to occur.

FIG. 10C illustrates placement of a modification of the shock absorbing portion of FIG. 10. A modified substrate 114 has latches (claws) 114a and 114b which are inserted into the notches 147a and 147b of recess 120, respectively, thereby attaching the shock absorbing portion to the back plate 2b of computer apparatus 1A. Indicator bumps 146 are provided on the back plate 2b to help a user insert latches 114a and 114b into notches 147a and 147b.

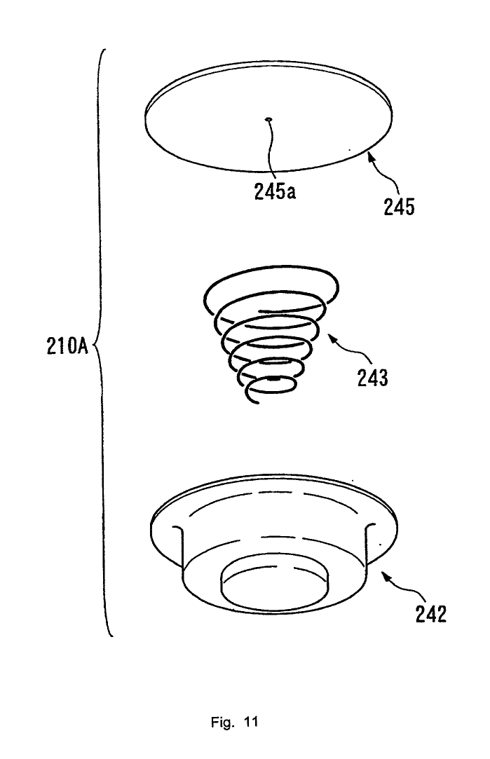

FIG. 11 illustrates a further embodiment of the shock absorbing portion 210A. A shock absorbing portion 210A shown in FIG. 11 includes a substrate 245 having an opening 245a for air ventilation at the center thereof, a spring 243, and a cap 242. In the shock absorbing portion 210A, the opening 245a formed in the substrate 245 is relatively small. The spring 243 is thicker than the springs 43 and 143 shown in FIGS. 8 and 10, respectively, and has a relatively large restoring force. Therefore, when the shock absorbing portion 210A shown in FIG. 11 comes into contact with the resting surface or the like, the shock absorbing portion 210A can be slowly collapsed because of the gradual outflow of air through the opening 245a formed in the substrate 245 and the restoring force of the spring 243. On the other hand, when the shock absorbing portion 210A is moved away from the resting surface 30 or the like, it can be rapidly restored to its original shape by the relatively large restoring force of the spring 243.

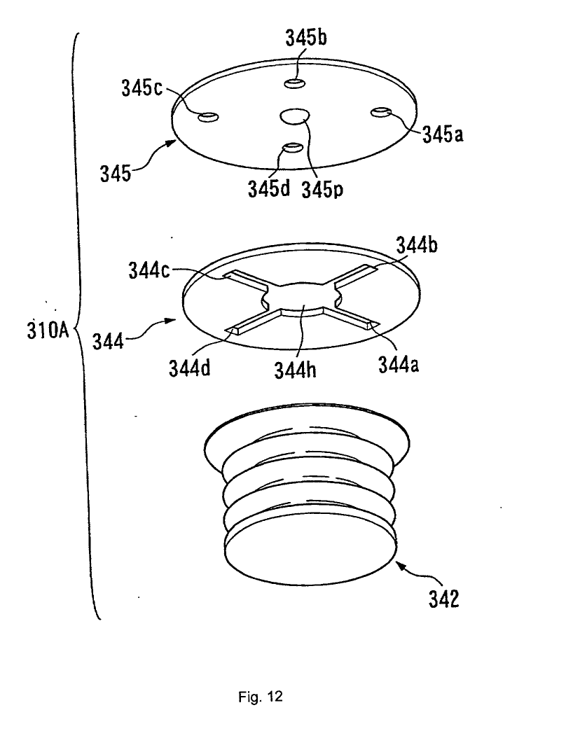

FIG. 12 illustrates another shock absorbing portion according to the present invention. A shock absorbing portion 310A shown in FIG. 12 includes a substrate 345 having a plurality of openings 345a, 345b, 345c, and 345d for air ventilation and a projection 345p, a valve 344 having an opening 344h at the center thereof, and an expansive bellows cap 342. The opening 344h formed in the valve 344 includes openings 344a, 344b, 344c, and 344d extending to points corresponding the openings 345a, 345b, 345c, and 345d in the substrate 345. In the shock absorbing portion 310A shown in FIG. 12, the cap 342, which may be made of a resin and the like, has restoring force providing restorability because of its bellows shape and can function the same as the spring. Therefore, the shock absorbing portion 310A shown in FIG. 12 can operate similarly to the shock absorbing portion 10A described above.

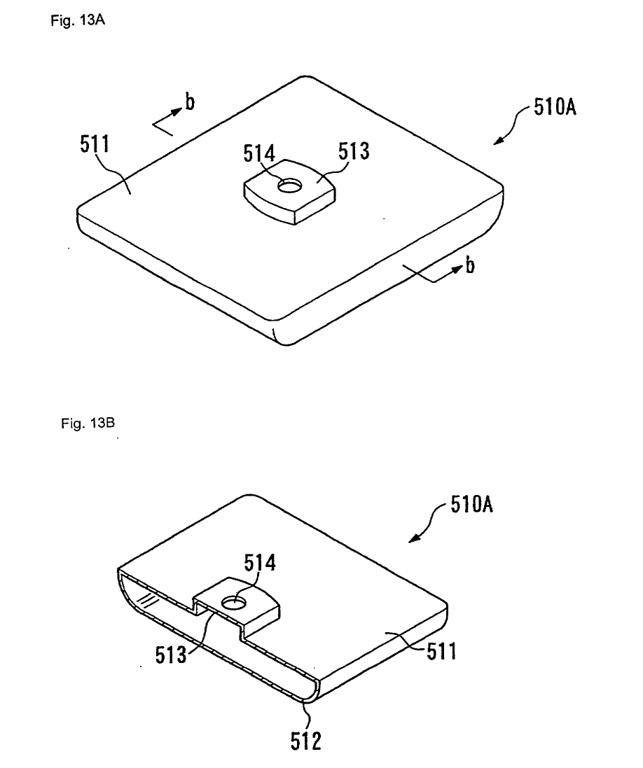

FIG. 13 illustrates a further modification of the shock absorbing portion, where FIG. 13A is a perspective view of a shock absorbing portion 510A, and FIG. 13B is a cross-sectional view of the shock absorbing portion shown in FIG. 13A taken along the line b-b.

A shock absorbing portion 510A shown in FIGS. 13A and 13B includes a valve 513 having an opening 514 for air ventilation provided on a top surface 511 to be joined with the back plate 2b of the computer apparatus 1A via the air ventilation substrate 40. In the shock absorbing portion 510A, the bottom surface 512 and top surface 511 are integrally made of a resin having a shape restoring force. The shock absorbing portion 510A can slowly discharge the air therein to the outside by means of the valve 513. On the other hand, when the collapsed shock absorbing portion 510A is restored to its original shape, the valve 513 allows air to relatively rapidly flow into an interior part of the shock absorbing portion 510A from the outside.

In a further embodiment of the present invention, in order to effectively absorb the vibration transmitted to the computer apparatus 1A, a support wall may be provided around the shock absorbing portions 110A, 110A, 210A, 310A, 510A and the like in the above-described embodiments.

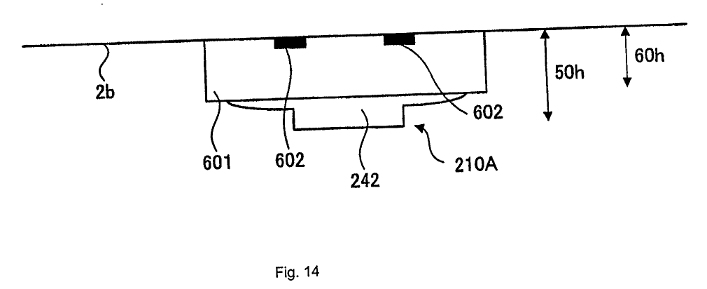

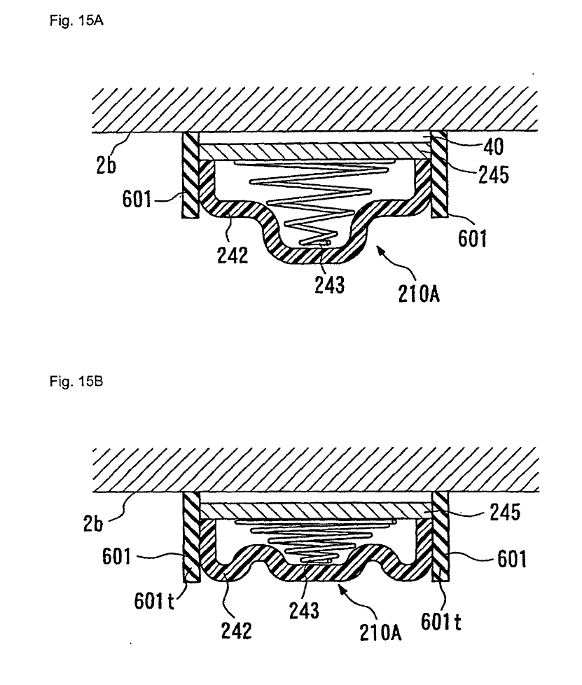

FIG. 14 is a partial side view of the computer apparatus 1A having the shock absorbing portion 210A with a support wall. FIG. 15 is a diagram for illustrating the function of the shock absorbing portion 210A with a support wall. FIG. 15A is a cross-sectional view illustrating a state where the computer apparatus 1A is distant from the resting surface 30, and FIG. 15B is a cross-sectional view illustrating a state where the computer apparatus 1A is in contact with the resting surface 30.

As shown in FIG. 14, a support wall 601 is provided on the back plate 2b of the computer apparatus 1A to surround the shock absorbing portion 210A shown in FIG. 11. The support wall 601 is made of a rubber having a higher rigidity than the cap 242, and the projection height 60h thereof from the back plate 2b (first distance) is less than the height 50h of the shock absorbing portion 210A (second distance) when the computer apparatus 1A is distant from the resting surface 30. In addition, a plurality of openings 602 for allowing air ventilation of the shock absorbing portion 210A are formed in the support wall 601 near to the back plate 2b of the computer apparatus 1A.

In the state where the computer apparatus 1A is distant from the floor surface 30 or the like and the shock absorbing portion 210A is not subjected to the self-weight of the computer apparatus 1A, as shown in FIG. 15A, the cap 242 of the shock absorbing portion 210A is inflated as a result of the expansion provided by the elastic restoring force of the spring 243 provided in the shock absorbing portion 210A, and the top of the cap 242 projects outwardly further than the support wall 601.

When the shock absorbing portion 210A is in the state where it does not bear the load of the weight of the computer apparatus 1A as described above, if the computer apparatus 1A is placed on the resting surface 30, then the cap 242 of the shock absorbing portion 210A is collapsed as shown in FIG. 15B so that the spring 243 in the cap 242 is collapsed. At this time, a top surface 601t of the support wall 601 is brought into contact with the resting surface 30, and thus the support wall 601 supports the self-weight of the computer apparatus 1A. When the support wall 601 supports the computer apparatus 1A in this way, the support wall 601 having a relatively high rigidity absorbs the vibration caused by operation of the CD-ROM device 6, such as the self-vibration.

The support wall 601 described above may be provided in combination with shock absorbing portion 210A as already shown, and may also be provided in combination with the shock absorbing portion 10A shown in FIGS. 6-9, shock absorbing portion 110A shown in FIGS. 10 and 10A, shock absorbing portion 310A shown in FIG. 12, shock absorbing portion 510A shown in FIGS. 13A and 13B and the like. Alternatively, the shock absorbing portions 10A, 110A, 210A, 310A, and 510A may be formed with the support wall 601 as the side wall thereof.

In the embodiments described above, the position where the shock absorbing portion 10A, 110A, 210A, 310A, or 510A is to be provided is not particularly restricted. In addition, together with the shock absorbing portion 10A, 110A, 210A, 310A, or 510A, the rubber pads 3a, 3b, 3c, and 3d provided on the computer apparatus 1 in the first embodiment may be provided on the computer apparatus 1A. Furthermore, the shock absorbing portion 10A, 110A, 210A, 310A, or 510A may be provided together with the shock absorbing portions 10 of the first embodiment. Any of the various shock absorbing portions described above may be provided in any combination with each other and with the rubber pads.

In addition, a rubber pad having a relatively high rigidity may be laminated on the top of the cap 42, 142, 242, or 342 of the shock absorbing portion 10A, 110A, 210A, or 310A, respectively, or on the surface of the shock absorbing portion 510A facing the resting surface 30.

In the embodiments described above, the computer apparatus 1, 1A on which the shock absorbing portion 10, 10A, 110A, 210A, 310A, or 510A is provided is the notebook PC. However, the shock absorbing portion according to the present invention is not limited thereto. For example, the shock absorbing portion 10, 10A, 110A, 210A, 310A, or 510A according to the present invention may be provided on any apparatus having a particular precision apparatus installed therein, for example, a desk-top computer apparatus, PDA (Personal Digital Assistant), peripheral devices such as an external HDD or CD-ROM device, projector, portable TV set, and portable DVD player.

In addition, the position where the shock absorbing portion 10, 10A, 110A, 210A, 310A, or 510A is to be provided is not limited to the positions shown in FIGS. 3, 5A, 6, 10B and 16C. For example, it may be provided at a position on the back plate 2b corresponding to the position where a particular precision apparatus, such as the CD-ROM 6, which is easily damaged by a shock, is provided.

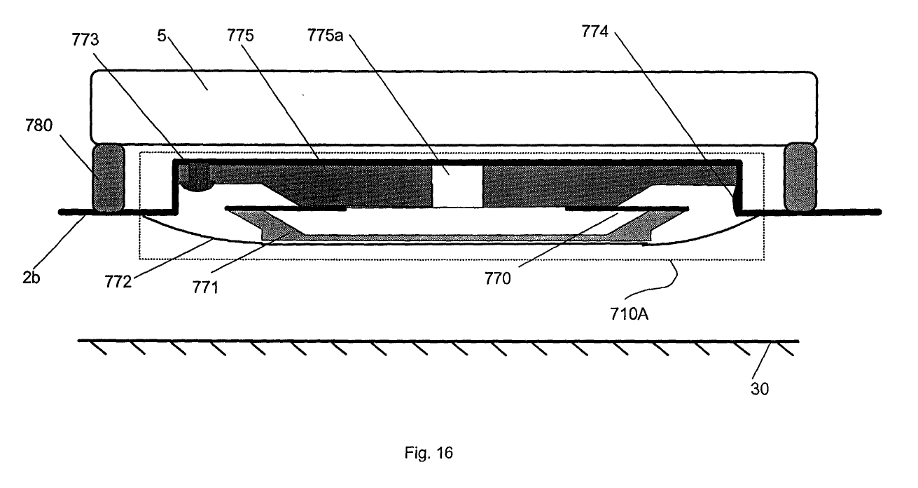

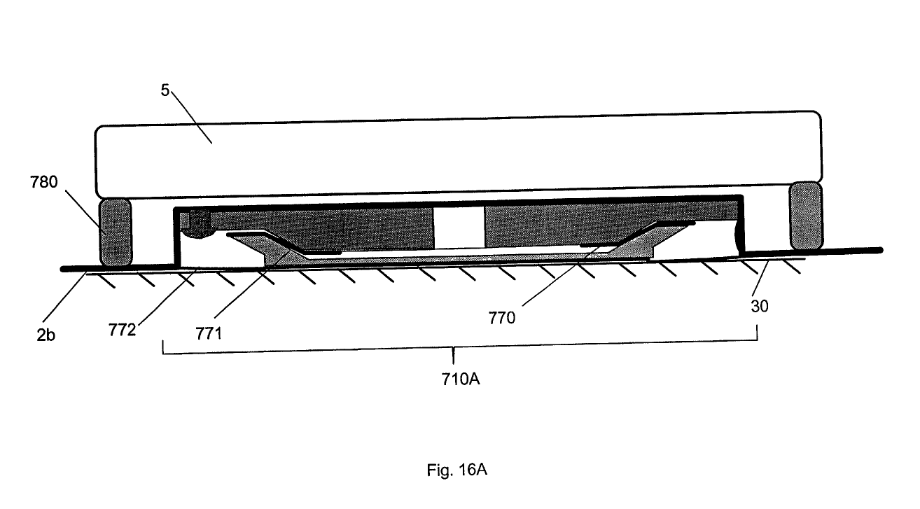

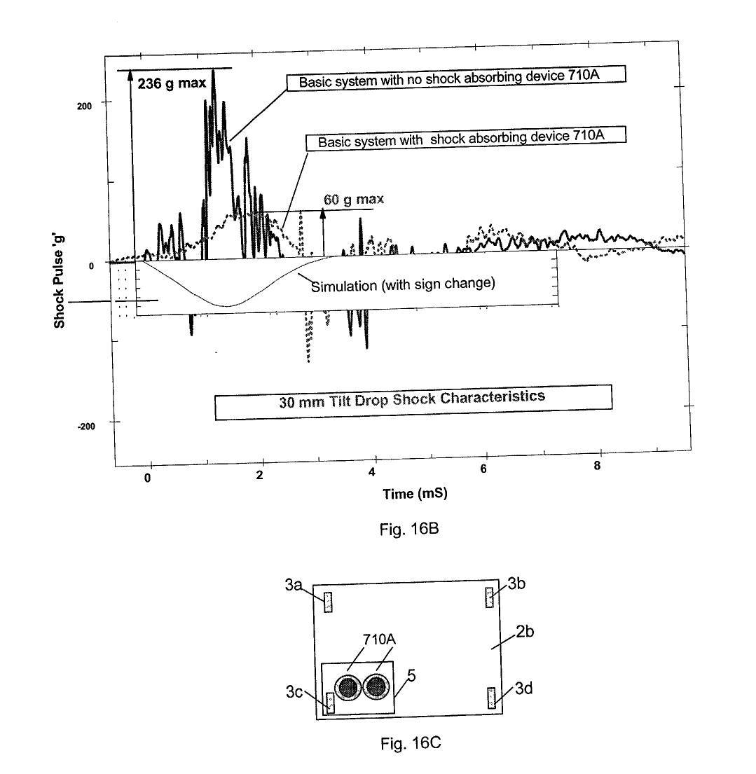

FIG. 16 illustrates a particularly preferred embodiment of a shock absorbing portion 710A provided in a position corresponding to a HDD 5. The shock absorbing portion 710A has a slim height construction and is constructed with few components. It has a single orifice 775A in substrate 775 to allow flow of air in and out of the device. The substrate 775 is connected to the outer disc 771 by an elastic membrane 770. The surface of disc 771 and substrate 775 which face elastic membrane 770 may be coated with a non-stick layer of a chemical compound so that long term storage of a computer apparatus will not glue the two discs 775 and 771 together. The shock absorbing portion 710A has a preferred cylindrical construction for the two members 775 and 771 facilitating increased change in compression volume of trapped liquid (air) for a given motion of disc 771 relative to disc 775, i.e. from a state where the shock absorbing member is not subject to the self-wieght of the computer and is fully expanded to a state where the computer apparatus is brought into contact with a surface. The disc shape of shock absorbing member 710A is designed for enhanced shock protection through increased surface area contact with resting surface 30.

The HDD 5 is mounted to the computer apparatus through a member 780 which is not related to this invention, but shown for completeness. Connector member 773 shows a first method of attaching the shock absorbing portion 750A to the computer back plate 2b which can be preferably a plastic pin with a head melted after the assembly or a conventional metallic screw. Ridge 774 is a second method of attaching shock absorbing portion 750A where a ridge 774 is formed on the entrance to the cavity through which the substrate 775 is pressed thus eliminating a need for pin 773. Covering 772 is a thin shroud made of wear resistant flexible sheet material and is attached to the outer (movable) disc 771. Covering 772 is designed to keep foreign material from entering the cavity and to protect the shock absorbing portion 650A from user handling.

FIG. 16A shows illustrates the embodiment of FIG. 16 when it is resting on a surface 30 showing the collapsed configuration of shock absorbing portion 710A.

FIG. 16B presents experimental data corresponding to test results of shock absorbing portions 710A used as shown in inset FIG. 16C. The results shown are for the 30 mm tilt drop shock characteristics of a notebook computer PC with and without the shock absorbing portions 710A as shown in inset FIG. 16C. Plotted is the shock pulse applied and the shock experienced by the PC with and without the shock absorbing portions 710A. Simulation data of the predicted shock response of a notebook PC having shock absorbing portions 710A is also superposed to show reproducibility of the shock protection mechanism. More than a factor of 3 reduction in peak shock is observed with use of the shock absorbing portions 710A.

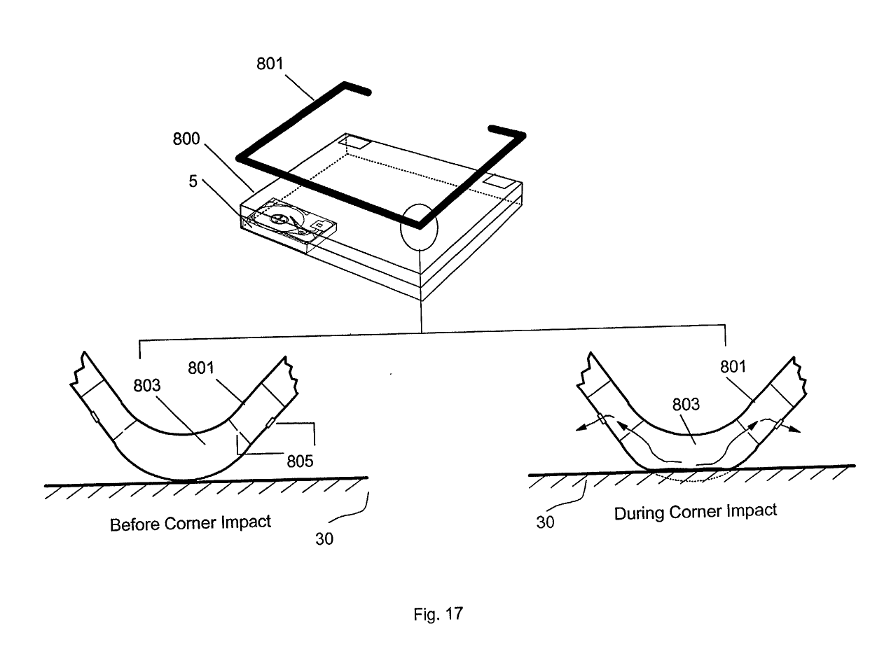

In yet another embodiment of the present invention, as shown in FIG. 17, a shock absorbing portion 801 may be provided to cover the peripheral edge of the housing of a notebook PC 800. The shock absorbing portion 801 is preferably partitioned into a plurality of small sections by a plurality of orifice plates. Each of the small sections contains a fluid, typically air. For example, when a corner of the housing of the PC 800 provided with the shock absorbing portion 801 is subjected to a shock caused by falling or the like as shown in the lower right of FIG. 17, the air in a small section 803 near the corner is gradually discharged to the outside through orifices 805 (see the lower left of the same drawing), and therefore the shock is reduced.

Furthermore, the size of the shock absorbing portions 10, 10A, 110A, 210A, 310A, 510A, or 710A is not limited to that as may be described in the above embodiments. Particularly, while the four shock absorbing portions 10A, 110A, 210A, 310A, 510A, or 710A provided on the back plate 2b of the computer apparatus 1A may be the same in size, they may alternatively be suitably adjusted, for example, may be different in size so as to respond to the weight distribution in the computer apparatus 1, 1A, or the usage situation or preference of the user.

Without departing from the spirit of the present invention, one or more of the structures described above may be properly selected, or modifications may be suitably derived from the structures described above.

What is claimed is:

1) A shock absorbing device for a precision apparatus, comprising a chamber having at least one opening for mass flow.

2) The shock absorbing device of claim 1, further comprising an elastic member.

3) The shock absorbing device of claim 1, further comprising a support wall provided around said chamber.

4) The shock absorbing device of claim 2, wherein said elastic member is disposed within said chamber.

5) The shock absorbing device of claim 4, wherein said elastic member is a spring.

6) The shock absorbing device of claim 2, wherein said chamber has a wall, and wherein said chamber wall comprises said elastic member.

7) The shock absorbing device of claim 6, wherein said wall further comprises an outer cap having a planar outer surface; and a substrate connected to an outer surface of said precision apparatus; and wherein said elastic member is between said outer cap and said substrate.

8) The shock absorbing device of claim 7, wherein said outer cap and said substrate comprise at least one of a metal, a metallic alloy and a hard plastic.

9) The shock absorbing device of claim 5, further comprising:
A substrate connected to an outer surface of said precision apparatus, wherein said substrate has a contact area defined by the surface area of said substrate in contact with said outer surface of said precision apparatus.

10) The shock absorbing device of claim 1, wherein said chamber further comprises a substantially leak free one-way valve, said valve permitting substantially no mass flow from a first inflated state to a second impact state, whereby the pressure within said chamber increases substantially adiabatically.

11) The shock absorbing device of claim 10, wherein under substantially no external applied force, said valve permits mass flow into said chamber, and said elastic member is in a substantially expanded state.

12) The shock absorbing device of claim 10, wherein said valve permits gradual mass outflow from said second impact state to a third rest state wherein said shock absorbing device provides substantially no resistance to the weight of said precision apparatus on a resting surface.

13) The shock absorbing device of claim 9, wherein said chamber further comprises a substantially leak free one-way valve, said valve permitting substantially no mass flow from a first inflated state to a second impact state, whereby the pressure within said chamber increases substantially adiabatically.

14) The shock absorbing device of claim 13, wherein said pressure increases according to:
F(t)=A*p₀*{V₀/V(t)}^{q}
Where:
A=the contact area of said substrate;
P₀=atmospheric pressure;
V₀=the volume within said chamber in said first state;
V(t)=the volume within said chamber in said second state;
q=adiabatic compression exponent;
t=time elapsed between said first state and said second state.

15) A precision apparatus for placing at a predetermined placement site, comprising:
A back surface that faces said placement site when the precision apparatus is placed at said placement site;
A viscoelastic member that contacts said back surface; and
A holder;
Wherein said viscoelastic member is held between said holder and said precision apparatus.

16) The precision apparatus according to claim 15, wherein a distance from a lowermost surface of said holder to said back surface of said precision apparatus is variable in response to deformation of said viscoelastic member.

17) The precision apparatus according to claim 16, wherein a minimum distance from said lowermost surface of said holder to said back surface of said precision apparatus is substantially equal to a distance from said placement site to said back surface of said precision apparatus when said precision apparatus is placed.

18) The precision apparatus according to claim 15, further comprising:
a support member for supporting said precision apparatus when said precision apparatus is placed at said placement site,
wherein said support member has a rigidity higher than that of said elastic member.

19) The precision apparatus according to claim 15, wherein
said back surface has a recess that is recessed to inside of said precision apparatus, and
said elastic member is disposed between said recess and said holder.

20) A portable computer apparatus, comprising:
shock absorbing means capable of being shrunk and having a restoring force; and
support means for supporting said computer apparatus when the computer apparatus is placed,
wherein said shock absorbing means projects outwardly further than said support means when the support means is not subjected to a self-weight of said computer apparatus.

21) The computer apparatus according to claim 20, wherein
said shock absorbing means absorbs a shock generated when said computer apparatus is placed, and
said support means absorbs a vibration generated after said computer apparatus is placed.

22) The computer apparatus according to claim 21, wherein said support means has a rigidity higher than that of said shock absorbing means.

23) A shock absorbing body capable of being attached to a precision apparatus, comprising:
a containing section for containing a fluid for absorbing a shock; and
an opening for introducing the fluid into said containing section and discharging the fluid from the containing section,
wherein a discharge speed of the fluid discharged from said containing section is lower than an introduction speed of the fluid introduced into the containing section.

24) The shock absorbing body according to claim 23, wherein a support member capable of supporting said precision apparatus is provided near said containing section.

25) The shock absorbing body according to claim 23, wherein the fluid contained in said containing section is a gas or a liquid.

26) A shock absorbing body capable of being attached to a portable precision apparatus, comprising:
a joint surface to be joined to said precision apparatus;
an elastic member for reducing a shock;
a holding member for holding said elastic member on said joint surface; and
a support member capable of supporting said precision apparatus, that is made of a material harder than said elastic member,
wherein when said shock absorbing body is in a free state, a first distance from said joint surface to an outermost portion of said holding member is larger than a second distance from the joint surface to an outermost portion of said supporting member.

27) The shock absorbing body according to claim 26, wherein when said precision apparatus is placed, said first distance is equal to or shorter than said second distance.
